(19) United States
(12) Patent Application Publication
(10) Pub. No.: US 2005/0043102 A1
(43) Pub. Date: Feb. 24, 2005

(54) Electronic miniature tag game

(76) Inventors: Sean Anderson, Westborough, MA (US); Mark Anderson, Westborough, MA (US); Matthew Von-Maszewski, Westborough, MA (US)

Correspondence Address: JONATHAN E. GRANT, 2107 HOUNDS RUN PLACE, SILVER SPRING, MD, 20906, US

(21) Appl. No.: 10/645,580

(22) Filed: Aug. 22, 2003

(51) Int. Cl. A63F 13/00

(52) U.S. Cl. 463/49

(57) ABSTRACT

A child-safe, easy-to-use, pocket-sized, thumb operated electronic apparatus using an infrared light as the communication medium between two or more participants for playing a game of electronic tag. The apparatus has a common surface that includes a thumb button and set of light emitting diodes on its topside for keeping score and a speaker in its bottom housing for emitting sounds. The apparatus incorporates a simulated radar by sending out a data packet at timed intervals announcing its presence to other like devices. The two-way communication feature allows for the transfer of text or voice messages between like devices. By holding down said button, the apparatus can toggle between displaying the number of hits received on the unit and the number of hits on displayed on an opponent's device.

This application claims priority under 35 U.S.C. 120 to 09/682,395, filed Aug. 29, 2001.

### BACKGROUND

1. Field of the Disclosure

The disclosure relates the field of games, specifically in the area of tag games incorporating an infrared light.

2. Description of the Prior Art

Over the years, several patents have been issued using projected light to simulate a projectile directed at a target or a like apparatus

U.S. Pat. No. 6,261,180 discloses a portable, programmable, interactive toy for a shooting game played by radiating and appropriately detecting infrared light (or other radiated energy). A player set includes an IR light projector (gun), an IR light detector (target), and a detachable, programmable data (or program) module that controls operation of the toy in accordance with data programmed therein. The data module may be detached, and the toy will operate in a default mode that is downwardly compatible with other toys that do not include the programmable data module. The toy also includes a base unit that programs the data modules to provide each player with a unique firing code. The data modules may also include circuitry that recognizes the different codes. The data modules may accumulate game and player information such as the number of shots fired by the associated gun, the number of hits registered by the associated target, and the source (player identification) of each hit registered. The base unit is a computer that programs the data module, uploads and downloads information, and processes information uploaded from the data module and provides the results of processing thereon, including computation results. The detachable data module provides modularity by that game functions and features implemented by modules may be added to and removed from a particular unit. The device has a complex matrix of play modes, functions, setups, options, and menus, including computer uploads and computer downloads, that can lead to confusion by the user.

U.S. Pat. No. 4,799,687 discloses a light projection tag game requiring the overlap of player projected images on a gaming surface. Each player is provided with an optical transceiver that has a receiver with a narrow field of view that is geometrically coincident with the light beam projected from the transceiver. Each player's transceiver can detect when an opponent's image that is also projected on the gaming surface enters this field of view thereby achieving a tag. Receiver methods use either signal transients or infrared modulation. Various embodiments include automatic targets, automatic game control, and projected gaming mazes.

U.S. Pat. No. 4,802,675 discloses a game comprising a toy gun and an electronic target that registers hits produced by the gun. The gun comprises an electronic flash tube connected to a circuit to produce a high voltage unidirectional supply from a low voltage supply. When the gun trigger is depressed, the flash tube is fired and the resulting light is concentrated to produce a relatively narrow beam of light. As well, an audio signal is produced for each press of the trigger. If the beam of light impinges on the electronic target, an audiovisual signal results to indicate a hit.

U.S. Pat. No. 4,898,391 discloses a target shooting apparatus utilizing a plurality of light beam emitting guns or rifles to shoot at a plurality of targets, the individual light beam guns being identified by frequency encoding the light beam emitted by each rifle. The first rifle to “hit” a target deactivates the target and is credited with a score. Light and sound effects are generated when a target is “hit” to simulate reality. The number of rifles and targets is limited only by the physical size of the apparatus that would be practical to accommodate the players

U.S. Pat. No. 5,375,847 A toy assembly including a ray gun capable of projecting a focused beam of light and an electro-mechanically actuable target figurine including a body, a support for supporting the body of the figurine in an upright position upon a surface, a light receiver, a toppling mechanism for causing the figurine to topple over when operated, an energy source within the figurine for powering the toppling mechanism, and a control circuit for initiating the operation of the toppling mechanism when the light receiver is struck by a beam of light projected by the ray gun.

U.S. Pat. No. 5,437,463 discloses a game apparatus that resembles a shooting gallery, the apparatus including a gun for projecting an electromagnetic beam such as an infrared light beam and a target assembly that includes a plurality of targets. Normally the targets are not visible, being concealed behind a two-way mirror, but during the operation of the game first one and then another target will become visible for a brief period of time as each target is illuminated by an illumination device, there being one illuminating device for each target. Each target has associated with it a beam receiver. If the electromagnetic beam strikes a target when it is illuminated, the associated beam receiver will cause a score to be registered due to the operation of additional electronics associated with the target assembly.

U.S. Pat. No. 5,577,962 discloses a gun game machine from which a player takes out and holds a model gun to play a game. When the number of operations of a trigger lever attains the preset number of times, the game is stopped and, at the same time, a solenoid operates to disengage a boss of a lever from a recess of an advance and retreat member and the advance and retreat member is ejected down by the effect of a spring. When the player pushes up the advance and retreat member to set, a sensor detects the pushing action and resets the trigger count value for enabling the game to continue. The action of pushing up the advance and retreat device is similar to the real action of loading a cartridge into a real gun and the player can enjoy a game having realism.

U.S. Pat. No. 5,672,106, discloses a combined totalizator and fixed odds betting system able to be operated both on and off-course via a central computer connected with communication links to a large number of betting terminals. Both totalizator wagering and fixed odds betting are conducted with a common pool. During the lead up to the race the fixed odds dividend to be paid is adjusted for each runner in stages in accordance with the potential liabilities arising at each stage from the bets to date as the pool increases in size toward race starting time.

U.S. Pat. No. 5,741,185 discloses a toy light projector or light gun and player-worn and self-propelled toy targets that detect light emitted by a toy light gun, and a toy shooting game that includes at least one toy light gun, and at least one toy target. The game is played by a player attempting to “hit” a target that provides audiovisual effects upon detecting light projected by the gun. A main target contains a light detector and all of the circuitry and audiovisual components needed to play a game, and an auxiliary target may contain a light detector and only some of the components needed to play a game and be coupled to a main target to share components therein. A self-propelled target includes circuitry that provides pseudorandom (or other pre-programmed or random) motion to the target. Squeezing a trigger causes the gun to emit light with a first code, and pressing a reset button causes the gun to emit light with a second code. The circuitry in a target decodes the codes and registers and counts hits for light detected with the first code, ending the game when a given number of hits is counted. In response to light detected with the second code, the circuitry in a target resets the count of hits and starts a new game. The gun can thus remotely reset the target. The gun has a reload feature that requires that a player “reload” the gun (press a reload button) after a given number of shots. Eight “AA” batteries are required.

U.S. Pat. No. 5,904,621 discloses a hand-held electronic toy gun and target apparatus facilitating a game of tag using infrared light communications between a plurality of players. An electronic controller is coupled to a transmitter for sending a series of encoded infrared light signals and a receiver for detecting infrared light signals. A gun body enclosing the controller, transmitter and receiver combination includes a handle with at least one hand operable trigger and a housing atop the handle conforming to the player's wrist and forearm. The housing has a top portion for mounting a nonplanar surface of a target window for exposing the target window upwardly and outwardly over a wide range of side angles. The housing further includes a front end portion forward of the handle for positioning an infrared light lens for focusing the series of encoded infrared light signals from the transmitter outwardly from the housing.

However, many of the above listed inventions have certain drawbacks. For instance, U.S. Pat. No. 6,261,180 has a complex matrix of play modes, functions, setups, options, menus, including computer uploads and computer downloads, that can lead to confusion by the user. Apparatuses like U.S. Pat. No. 5,741,185 use eight “AA” batteries.

### SUMMARY OF DISCLOSURE

An electronic game of tag is disclosed comprising at least two two-way communication information units. The two communication units send out packets of information at predetermined intervals to similar information units. A similar information unit can read the packet and sense that there is another device in the room and alert the user. This feature simulates radar.

In one embodiment of the disclosure, the communication units have a geometric shape. They can be round or square, and are no greater than about 2″×2″ and more preferably 1″×1″. This will contrast with U.S. Pat. No. 5,904,621, and No. 5,741,185, that have the look and feel of a gun or a weapon, albeit a simulated gun or weapon.

It is an object of the present disclosure disclosed herein to provide a true game of electronic tag, not a simulation of a gun fight.

It is another object of the present disclosure disclosed herein to provide a game of electronic tag that eliminates the gun-like elements of earlier electronic games including the handle, trigger, and barrel.

It is another object of the present disclosure disclosed herein to provide a simpler game of electronic tag for small children where all the functions are operated by a single thumb button to increase the apparatus' ease of use and lessen any learning required to play.

It is another object of the disclosure disclosed herein to provide a game of electronic tag where the apparatus has two-way communications built into the device, such that a unit can send out a data packet at timed intervals that can be read by a like unit with the result being a simulated radar feature.

It is another object of the present disclosure disclosed herein to provide a game of electronic tag where the infrared transmitter and infrared receiver are on the forward facing surface of the housing for face-to-face game play either indoors or in the back seat of a car or similar situation.

It is another object of the disclosure to allow the user to toggle between two scoring display modes. The first mode displays the number of times the holder of the unit has been hit. The second mode displays the number of times the holder's opponent has been hit.

It is another object of the present disclosure disclosed herein to provide a game of electronic tag where the apparatus can be attached to a belt loop or backpack by a key chain or lanyard.

It is another object of the disclosure disclosed herein to minimize the number of batteries needed to play the game and their associated cost.

It is another object of the present disclosure disclosed herein to provide a game of electronic tag where the miniature form factor, simplified circuitry, simplified construction, and the low cost of batteries will reduce the overall cost to the consumer.

The apparatus herein described is a pocket-sized, thumb operated, electronic game using infrared light as the communication medium to send signal data packets between two or more participants for playing a game of tag. The apparatus is similar in size and shape to a modern keyless car door opener. The device incorporates two-way communications between similar devices that allow for transferring of the score or hit count, the simulation of radar, and voice and text messaging. The apparatus is designed for parents who do not want their children exposed to simulated guns or weapons at an early age. The form factor is distinctly unlike that of a simulated gun or weapon. The apparatus has improvements for safety, ease-of-use, portability and power consumption, and is manufactured at a desirable cost to acquire.

Additional objects and advantages of the present disclosure will become apparent to one of ordinary skill in the art and upon a perusal of the following specifications, claims, and drawings.

### BRIEF DESCRIPTION OF DRAWINGS

FIG. 1 is the conventional view of the top, front, and side of the apparatus.

FIG. 2 is a top view of the exterior of the top housing of the apparatus.

FIG. 3 is a top view of the exterior of the bottom housing of the apparatus.

FIG. 4 is a top view of the inside of the bottom housing.

FIG. 5 is a top view of the inside of the top housing.

FIG. 6 is a cutaway view of the left side of the apparatus at the center point of the apparatus along the vertical axis.

FIG. 7 is a schematic drawing of the electronic circuitry.

FIG. 8 is a rendering of a modulated square wave.

FIG. 9 is rendering of an encoded transmission signal.

### DETAILED DESCRIPTION

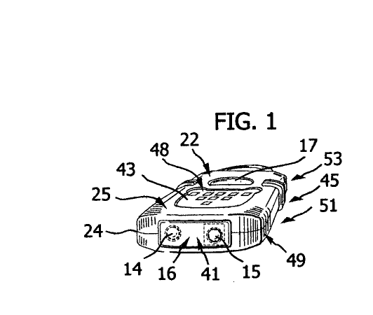

FIGS. 1-9 depict the preferred embodiments of a thumb operated, pocket-sized, electronic apparatus using infrared light as the communication medium between two or more participants for playing a game of tag.

More specifically, FIG. 1 shows a comprehensive view of the apparatus and its general shape and form factor. The apparatus has a narrow rectangular housing 51. The lights 48 are forward of the button 17 in the thin, elongated enclosure 45. The drawing shows the transmitter 14 and receiver 15 placed forward of the lights 48 in its slim oblong case 53. The drawing also shows the forward face 16 being a common surface 41 containing both an infrared transmitter 14 and an infrared receiver 15.

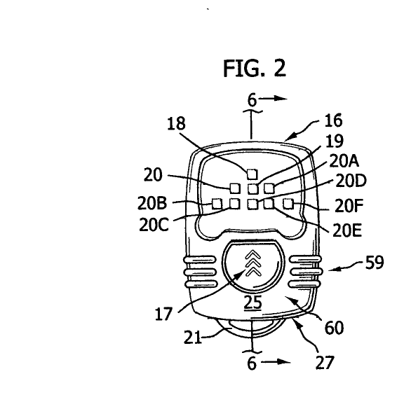

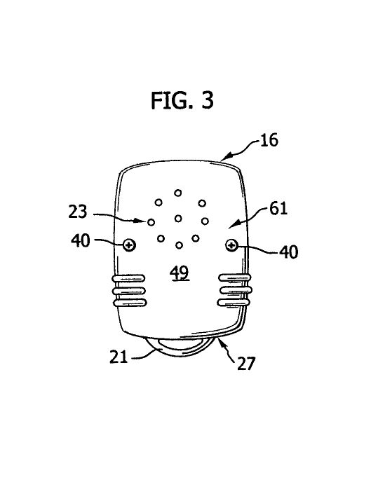

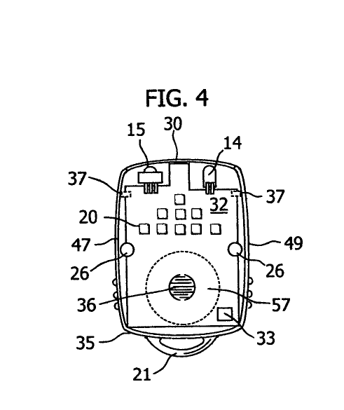

As shown in FIG. 1, the disclosure is centered around a narrow rectangular housing 51 made of plastic that allows the user to hold the apparatus between the thumb and index finger. The button 17 is the principal method of interacting with the apparatus. The button 17 controls of the functions in concert with a microprocessor 33 (FIG. 4). The drawing shows a second common surface 22 shared by both the button 17 and the lights 48. Also shown is the seam 24 that exists between the top housing 25 and bottom housing 49. Additionally, the drawing shows the top face 60 (FIG. 2) parallel to the bottom face 61 (FIG. 3) of the narrow rectangular housing 51 and a transparent screen 43 that covers the lights 48.

The top view of the exterior of the top housing 25 has a nongun form factor with the main dimensions in one embodiment being approximately 43 mm long, by 32 mm wide, by 12 mm thick, to fit in a pocket. The button 17 and light emitting diodes (LEDs) 18, 19, and 20-20F share a common surface 22 for playing and for showing the user the score. The first light is a red LED 18, then three yellow LEDs 19, 20, and 20A and the remaining are green LEDs 20-20F. The preferred position of the plurality of lights 48 and forward of the button 17 is shown, although this is not the only arrangement possible. The apparatus includes a key ring attachment member 21 at the rear face 27 of the apparatus to connect to a keying and a raised, decorative element 59 that wraps from the front to the back of the narrow rectangular housing 51.

As shown in FIG. 3, the top view of the exterior of the bottom housing 49, the apparatus has holes 23 to allow sound to pass through from the internal sound emitter 29. Screws 40 are used to join the top housing 25 and the bottom housing 49, although the top and bottom housings may be snapped together, etc. At the rear face 27 of the apparatus is the key ring attachment member 21.

Side wall 35 is preferably 2 mm thick, with a female flange 47. There is a boss with hole 26 at the side of the apparatus that is used with a screw 40 when assembling the top housing 25 and the bottom housing 49 of the apparatus. There are posts 37, preferably about 2 mm, that act as support areas for the printed circuit board 32.

The side wall construction of the apparatus comprises a side wall 35 (preferably 1 mm thick), with a male flange 28. There is a boss with hole 26 at the sides of the apparatus for a screw 40 (FIG. 3) that is used when assembling the top housing 25 (FIG. 2) and the bottom housing 49 (FIG. 3) of the apparatus. There are two posts 37 (again preferably 2 mm) that act as a support area for the printed circuit board 32.

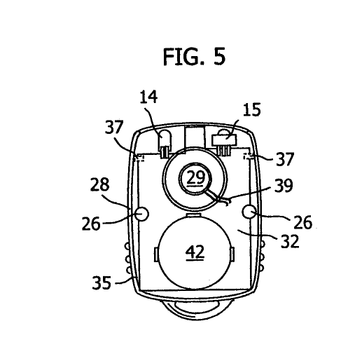

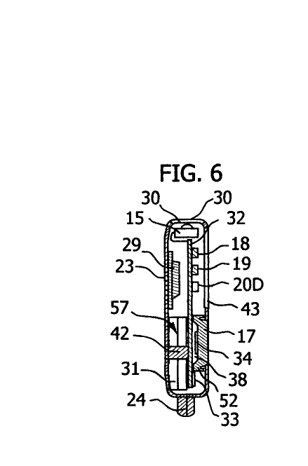

Also drawn in FIG. 5 is the location of the printed circuit board 32 showing the position of the sound emitter 29, and the battery cage 42 for the power supply 57 (FIG. 6) consisting of batteries 31. The battery cage 42 is to the back face of the printed circuit board 32. Additionally, the drawing shows the position of two small gage wires 39 soldered on the face of the printed circuit board 32 that connects to the sound emitter 29.

As shown in FIG. 6, the left side cutaway view, at the center point of the apparatus, the printed circuit board 32 is sandwiched between the button 17 and lights 48 (FIG. 1) or LEDs 18-20F (FIG.2), and the sound emitter 29 and the power supply 57 (FIG. 6) or batteries 31. It also shows the preferred layout of electronics as they are attached to a one mm printed circuit board 32. The power supply 57 of this embodiment is a pair of CR2032 coin cell or equivalent batteries 31 that are nested in a battery compartment 42 and have a nominal capacity of less than 1000 milliampere hours of electricity. Theoretically, more powerful batteries could also be used. The infrared transmitter 14 and infrared receiver 15 are soldered to the top of the printed circuit board 32. A plurality of LEDs 18, 19, 20-20F (FIG. 2) are mounted to the printed circuit board 32. Likewise a microprocessor 33 (FIG. 4) and a button 17 with a conductive base 34 are also mounted on the printed circuit board 32.

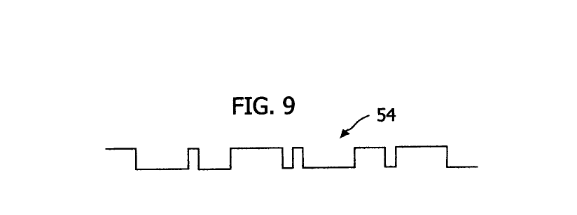

The conductive base 34, when manually actuated, completes a circuit that causes the infrared transmitter 14 to send out an encoded transmission signal 54 (FIG. 9). The button 17 is recessed in relationship to the plane of the top housing 25 (FIG. 2) to prevent accidental firings. The button 17 has a resilient flange 52 (preferably rubber) and a cavity 38 at its bottom. The button 17 with a cavity 38 at its base keeps the conductive base 34 of the button 17 from touching the printed circuit board 32. Depressing the button 17 causes the cavity 38 to close and for contact to be made between the conductive base 34 and the printed circuit board 32 completing the circuit. Releasing said button 17 causes the cavity 38 to open and the button 17 to return to its original position opening the connection. The resilient flange 52, which is preferably made out of rubber, prevents button 17 from dropping out of the top housing 25 (FIG. 2).

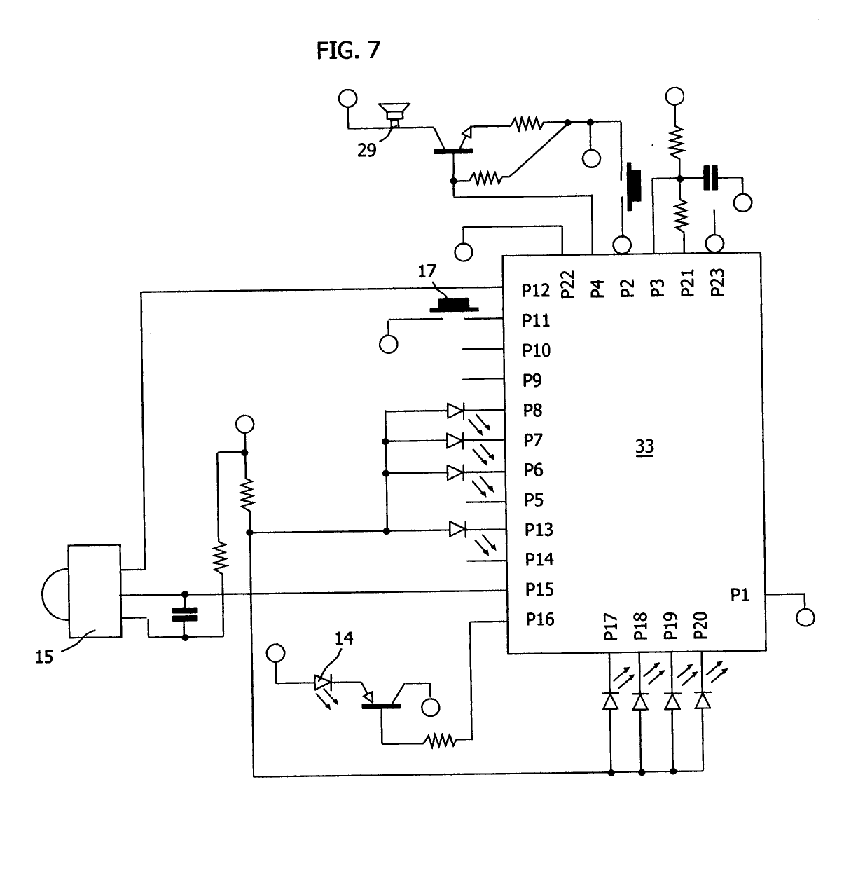

FIG. 7 shows the electrical connections between the above mentioned components and the microprocessor 33. The microprocessor in this embodiment of the disclosure is a WinBond 4-bit microprocessor manufactured by Winbond Electronics of Japan. Similar 4-bit microprocessors can be substituted to perform the same functions. The microprocessor 33 has the following power states: off state, reset state, run state, and sleep state. The off state only occurs when the batteries 31 (FIG. 6) are removed or are discharged. The reset state occurs when batteries are initially inserted into the battery cage 42. The reset state is momentary and resolves into the run state. The run state is maintained for five minutes after the device has received data packets via the infrared receiver 15, or the player has pressing the button 17. The run state resolves to the sleep state after five minutes of inactivity in the run state. The sleep state resolves back to the run state if the button 17 is pressed.

When the button 17 is pressed, the device will move from sleep state to run state if necessary. An infrared data packet is transmitted containing the following information: fire action type and this device's hit count. The transmission is followed by a blink of the red LED 18 and a sound via sound emitter 29.

When the infrared receiver 15 detects a data packet, it passes the signal to the microprocessor 33. The data packet is decoded into one of three actions: fire action type, opponent score type, and opponent score query type. Each of these data packet types causes different operational action. The fire action type causes this receiving unit to store the opponent's hit score contained in the message. It also updates its internal count of hits. The microprocessor 33 updates the green score LEDs 20B-20F with this internal count and plays a sound. The microprocessor 33 then transmits via the infrared transmitter 14 an opponent score type data packet. If the hit count has reached the maximum, a unique sound is played and the hit count resets to zero. The receipt of an opponent score packet causes the receiving unit to test for a win condition against the opponent. If so, the device plays a unique victory sound. An opponent score query type packet is a request for this unit to silently transmit its internal hit score.

The opponent score query type data packet is used to provide a “radar” feature. One unit can transmit the opponent score query type data packet. If there is no response, the unit can assume no opponents are near. If an opponent is near, the opponent will reply to the packet. This knowledge of near or not near provides a radar like function to the game play.

Each device is aware of other devices. Each device is able to display the score (or hits) against itself and the score against the opponent device. Prior devices were limited to displaying the score against self and had no awareness of the score of the opposing devices; thus, there was no way of knowing when the user operator “won.” This awareness comes through the transmission of game information in the coded infrared signal.

The transmitted signal has several possible meanings to the receiving device. The transmitted signal has multiple meanings, in contrast to previous electronic tag games. The encoded signal allows units present varying responses to the user based upon the signal content. This content could be expanded to include transmitting voice and text messages.

The tag devices communicate in a bidirectional fashion. One device may send an encoded transmission signal that requests information from another device. The bidirectional signals allow for game features that extend beyond prior patents.

If one devices “fires” and successfully “tags” another device, the “tagged” device sends a tag confirmation message to the firing device.

Bidirectional messaging allows the electronic tag game to simulate real world devices to enhance game experience. The “radar” feature relies upon one device initiating a special signal without user direction. One or more opponent device(s) can reply, allowing both initiating device and opponent devices to present the user with simulated information.

The devices have a feature that allow them to simulate a real world radar. The electronic tag device is able to present its user with a visual clue as to whether or not opponents are present (hiding) nearby. The initiating device transmits a coded infrared signal. This signal is self initiated by the device, not the user. Any opponent devices that receive the signal know that the initiating device is “near.” These receiving opponent devices transmit a reply message to the initiating device, confirming their presence to the initiating device. All units that participate in this coded signal exchange will notify their users that opposing players are nearby. This feedback to the user is a simulation of real world radar usage.

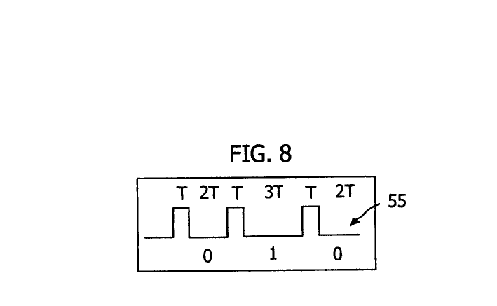

FIG. 8 shows the data packet bit pattern 55 that makes these machinations possible. The pattern is a series of six data bits: header bit, high count bit, medium count bit, low count bit, type bit, and trailer bit. The header and trailer bits merely delineate the beginning and end of a data packet. The header packet is used to warn receiving units that data are about to arrive. It provides a delay necessary for slow microprocessors to initiate the data decode logic. The next three bits typically indicate the hit count of the transmitting unit. There are special cases where impossible counts are used to vary the packet meaning, as in with the opponent score query. The type bit is set to indicate a fire type packet. It is clear for opponent score and opponent score query. The trailer bit is used only to mark the end of a valid packet.

Referring to FIG. 9, the infrared transmission pattern is composed of 1,200 Hz signaling rate carried on a 38,000 Hz carrier wave. Each data cell contains multiple transitions of “on” and “off” pulses from the IR transmitter. The timing of the cell pulses occurs according to the timing of the 1,200 signal rate. An on state is represented by the transmission of infrared light pulsed at the 38,000 Hz carrier frequency for the duration of one 1,200 Hz wave cycle. A data cell for a “1” bit contains six “on” states followed by the equivalent of six Off states. A data cell for a “0” bit contains two “on” states followed by the equivalent of six “off” states. The microprocessor decodes the number of On states it sees within a given period to decode the “1” and “0” bits.

Game variations are possible by holding the button 17 down for five seconds. The internal software selects alternate game and/or display logic upon noticing the button held for this extended period. Initial usage is to switch the green LEDs 20B-20E to display the opponent's hit count instead of this device's hit count.

Many modifications and variations of the present disclosure are possible in light of the above teachings. It is, therefore, to be understood within the scope of the appended claims the disclosure may be protected otherwise than as specifically described.

1) An electronic game of tag, comprising at least two firing units, each of said firing mechanisms comprising:
(a) a housing;
(b) at least one button emerging from the top of the housing;
(c) a plurality of lights emerging from said housing;
(d) a sound emitter;
(e) an infrared transmitter capable of transmitting a data packet;
(f) an infrared receiver;
(g) a circuit board;
(h) a power supply;
(i) an encoded transmission signal; and
(j) a microprocessor capable of decoding said data packet;,
wherein when said infrared receiver of a first said firing unit detects said data packet from said infrared transmitter of a second said firing unit, transmits said data packet, said infrared receiver of said first said firing unit passes a signal of said data packet to said microprocessor where said data packet is decoded into an action selected from the group consisting of fire action type, opponent score type, and opponent score query type, such that said fire action type causes said first said microprocessor to:
(a) store the opponent's hit score contained in the message;
(b) update internal count of hits;
(c) update green score LEDs 20B-20F with this internal count; and
(d) plays a sound, whereupon the first said microprocessor then transmits via the infrared transmitter an opponent score type data packet.

2) The electronic game of tag according to claim 1, wherein said housing is a narrow rectangular structure.

3) The electronic game of tag according to claim 1, wherein if the microprocessor recognizes that the hit count has reached the maximum, a unique sound is played and the hit count resets to zero.

4) The electronic game of tag according to claim 3, wherein said receipt of an opponent score packet causes the receiving unit to test for a win condition against the opponent.

5) The electronic game of tag according to claim 4, wherein said firing unit plays a special victory sound when a win condition exists.

6) The electronic game of tag according to claim 1, wherein the top face of said narrow rectangular housing is a common surface containing at least one button and a plurality of lights.

7) The electronic game of tag according to claim 1, wherein the bottom face of said narrow rectangular housing has a plurality of holes.

8) The electronic game of tag according to claim 1, wherein the plane of said top face of said narrow rectangular housing is parallel to the plane of said bottom face of said narrow rectangular housing.

9) The electronic game of tag according to claim 1, wherein said circuit board is sandwiched between said button and said lights.

10) The electronic game of tag according to claim 1, wherein a forward face of said narrow rectangular housing in claim 1 is a common surface shared by said infrared transmitter and said infrared receiver.

11) The electronic game of tag according to claim 1, wherein the interior of said narrow rectangular housing has partitions between said infrared transmitter and said infrared receiver.

12) The electronic game of tag according to claim 1, wherein said encoded transmission signal is an asymmetrical transmission pattern.

13) The electronic game of tag according to claim 1, furthering comprising a key ring attached to the housing.

14. The electronic game of tag according to claim 1, wherein said button is recessed in relationship to the plane of said thin, elongated enclosure.

15. The electronic game of tag according to claim 1, wherein said plurality of lights are located forward of said button.

16. The electronic game of tag according to claim 1, wherein said infrared transmitter and said infrared receiver are forward of said button.

17. The electronic game of tag according to 1, wherein said power supply is comprised of at least one coin cell battery.

18. The electronic game of tag according to claim 1, wherein said power supply has a nominal capacity of less than 1000 milliampere hours of electricity.

19. The electronic game of tag according to claim 1, wherein at least two mechanisms participate in bi-directional information exchanges.

20. The electronic game of tag according to claim 1, wherein radar can be simulated by self-initiated, bi-directional information exchanges.
